(19) United States
(12) Patent Application Publication
(10) Pub. No.: US 2017/0105490 A1
(43) Pub. Date: Apr. 20, 2017

(54) THREE-DIMENSIONAL MEASUREMENT SYSTEM FOR MARKED LINE FOR ADHERING SOLE TO UPPER AND THREE-DIMENSIONAL MEASUREMENT METHOD THEREFOR

(71) Applicant: ORISOL ASIA LTD., Chang Hwa (CN)

(72) Inventors: Jakov MAKOVER, Maccabim (IL); Bar Cochva MARDIX, Tel Aviv (IL); Yaacov SADEH, Rechovot (IL)

(73) Assignee: ORISOL ASIA LTD., Taiwan (CN)

(21) Appl. No.: 15/127,111

(22) PCT Filed: Mar. 27, 2014
(86) PCT No.: PCT/CN2014/074183

§ 371 Date: Sep. 19, 2016

(51) Int. Cl. A43D 1/08; A43D 111/00; G06T 7/70; G01B 11/25; H04N 13/02; A43D 8/26; A43B 3/00

(52) U.S. Cl. CPC A43D 1/08; A43D 8/26; A43D 111/00; A43B 3/0005; G01B 11/2518; H04N 13/0253; G06T 7/70; G06T 2207/10028

(57) ABSTRACT

A three-dimensional measurement (C) system for a marked line for adhering a sole (A) to an upper (B) and a three-dimensional measurement method therefor. A three-dimensional structure of a sole inner surface (A1) is measured automatically using a three-dimensional scanner (30), so as to form three-dimensional inner surface data (201) of the sole (A); and by conducting operation processing on the three-dimensional inner surface data (201) of the sole (A) and three-dimensional surface data (202) of the upper (B), a contour line (A2) of the sole inner surface (A1) is transferred to an upper lower surface (B1), so as to form a processing marked line of the upper (B), thereby improving the operation efficiency of adhering the sole (A) to the upper (B).

### BACKGROUND OF THE INVENTION

Field of the Invention

The present invention relates to adhering operation for adhering a sole to an upper of a shoe, and more particularly to a three-dimensional measurement system for a marked line for adhering a sole to an upper and a three-dimensional measurement method therefore.

Related Prior Art

Sneaker essentially includes an upper to cover the sole of the foot, and a sole connected to the upper. The sole of a sneaker has a complicated shape, so that the contour line of the sole inner surface which is to be adhered to the lasted upper is also complicated, which makes it difficult to apply glue or treatment agent to the contour line of the sole inner surface, and resulting in poor bonding when the sole is adhered to the upper.

To solve the abovementioned problem, someone proposed that the upper lower surface and the sole inner surface must be subjected to a roughening treatment before adhering the sole to the lasted upper, then glue is applied to the upper lower surface and the sole inner surface, so that the bonding effect is enhanced by roughening the upper lower surface and the sole inner surface. When the roughening treatment or the application of glue is not performed well, the upper and the sole are very likely to separate from each other and form a rip. Besides, after the roughening treatment or application of glue, the roughened surface is likely to appear at the periphery of the upper lower surface, or glue might overflow to visible area, causing reduction in quality of the sneaker.

Therefore, currently, the adhering operation of the upper and the sole can only be carried out by manual. A shoemaker uses a sole of the required shape and size as a template and draws by hand a working line by drawing along the periphery of the upper lower surface. Then, the shoemaker uses a grinding wheel to roughen the area of the upper within the working line. Finally, another shoemaker apply glue or treatment agent to the roughened area.

The manual adhering operation has the disadvantage of low efficiency, and the adhering quality depends a lot on the skill of the shoemaker. When the shoemaker is tired, mistakes are inevitable, and quality cannot be assured. Besides, the sole template itself has a manufacturing tolerance of several millimeters, therefore, using a single sole template to drawing the working line cannot ensure that the position of the working line on every upper is correct.

Currently, visual imaging system has been used to detect the glue line between the sole and the lasted upper by putting the sole onto the upper, and rotating the video camera along the border of the upper and the sole. However, this cannot be done fully automatically and still requires a lot of manual work to be done by the shoemakers.

The present invention has arisen to mitigate and/or obviate the afore-described disadvantages.

### SUMMARY

The present invention is aimed at providing a three-dimensional measurement system for a marked line for adhering a sole to an upper and a three-dimensional measurement method therefore, which are used to measure the sole and the upper which are carried in pair by the conveyor of a shoe production line, so as to obtain a digital data of the processing marked line for adhering the sole to the upper, and thus achieving the purposes of automatic production, improving production efficiency and quality.

To achieve the above objective, a three-dimensional measurement system for a marked line for adhering a sole to an upper, in accordance with the present invention is used to measure the sole and the upper which are carried in pair by a conveyor of a shoe production line, and the three-dimensional measurement system includes: a database stored with three-dimensional surface data of the upper; a three-dimensional scanner is mounted on the conveyor via a slideway to scan the sole, a projector and a video camera are slidably mounted on the slideway via a rack, projection lines of light rays generated from the projector are located within a coverage area of the video camera, the projection lines of the three-dimensional scanner are projected onto different parts of the sole inner surface of the sole to create a set of deformation during movement of the sole, measuring displacement distance between the rack and the slideway can create a projection-line displacement data; an identification device is used to identify a built-in identification data in a tag of the upper carried by the conveyor; and a processor is connected to the database, the three-dimensional scanner and the identification device, and serves to read the three-dimensional surface data of the database and the built-in identification data to obtain a three-dimensional surface data of the upper which is conformed to the upper, the processor reads the set of deformation and the projection-line displacement data of the three-dimensional scanner to create a three-dimensional inner surface data of the sole, the processor conducts calculation based on the three-dimensional inner surface data of the sole and the three-dimensional surface data of the upper, and transfers the contour line of the sole inner surface of the sole to the upper lower surface of the upper to form a processing marked line.

A three-dimensional measurement method used in combination with the above-mentioned three-dimensional measurement system to measure the sole and the upper which are carried in pair by the conveyor of the shoe production line, and mark the processing marked line for adhering the sole to the upper, characterized in that the three-dimensional measurement method comprises: a step S1 of obtaining the three-dimensional surface data of the sole includes: moving the sole carried by the conveyor into a coverage area of the video camera of the three-dimensional scanner, shooting and measuring with the three-dimensional scanner the set of deformation formed by the projection lines and the projection-line displacement data which are then outputted to and processed by the processor, so as to obtain the three-dimensional inner surface data of the sole inner surface of the sole; a step S2 of obtaining a three-dimensional surface data of an upper includes: moving the upper carried on the conveyor to an identification area of the identification device, the processor uses the identification device to read the built-in identification data in a tag of the upper and read the three-dimensional surface data of the upper from the database via the identification data, thus obtaining the three-dimensional surface data of the upper which is conformed to the upper; a step S3 of modifying the sole inner surface includes: processing, by the processor, the three-dimensional inner surface data of the sole and the three-dimensional surface data of the upper, digitally controlling the sole inner surface of the sole to create a three-dimensional surface which is conformed to the upper lower surface of the upper on the sole inner surface of the sole; and a step S4 of marking a line on the upper includes: processing, by the processor, the three-dimensional inner surface data of the sole and the three-dimensional surface data of the upper, and transferring the contour line of the sole inner surface of the sole to the upper lower surface of the upper to form the processing marked line.

Preferably, the tag is a radio frequency identification tag or a barcode label which allows the reader of the identification device to read the built-in identification data via Radio frequency identification technology or barcode recognition technology.

Preferably, the three-dimensional surface data of the upper can also be obtained by three-dimensional scanning The measurement system of the present invention is used to measure the sole and upper which are carried in pair by a conveyor of a shoe production line. When the sole and the upper which are carried in pair are arranged in a parallel manner on the conveyor, the three-dimensional measurement system of the present invention can be provided with another scanner to scan the three-dimensional surface data of the upper in addition to the three-dimensional scanner for scanning the sole inner surface. When the three-dimensional scanner are arranged linearly in a front and back manner on the conveyor, the three-dimensional scanner can scan and send the three-dimensional inner surface data of the sole and the three-dimensional surface data of the upper B to the processor.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an assembly view of the present invention showing that the sole is adhered to the sole of a shoe;

FIG. 2 shows the three dimensional inner surface of the sole in accordance with a preferred embodiment of the present invention;

FIG. 3 shows the three dimensional surface of the upper in accordance with a preferred embodiment of the present invention;

FIG. 4 is an operational view of the present invention showing that the three dimensional scanner is scanning the sole inner surface;

FIG. 5 is an illustrative view showing the three dimensional measurement system in accordance with the preferred embodiment of the present invention;

FIG. 6 is a flow chart showing the three-dimensional measurement method therefore in accordance with the preferred embodiment of the present invention; and

FIG. 7 is a flow chart showing the steps of calculating the contour line in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

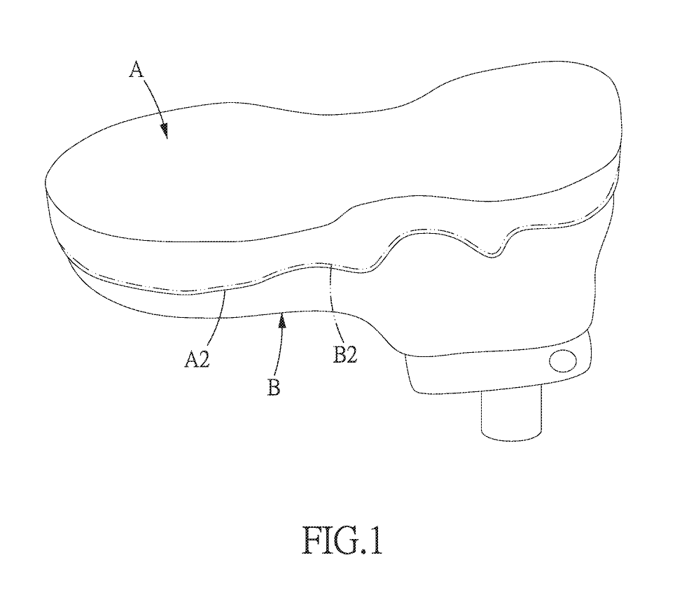

Referring to FIGS. 1-6, a three-dimensional measurement system for a marked line for adhering a sole to an upper and a three-dimensional measurement method therefore in accordance with the preferred embodiment of the present invention are shown.

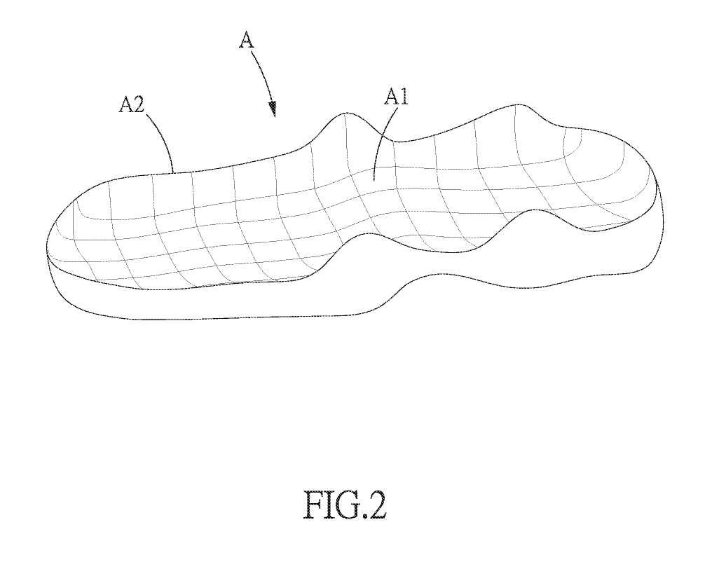

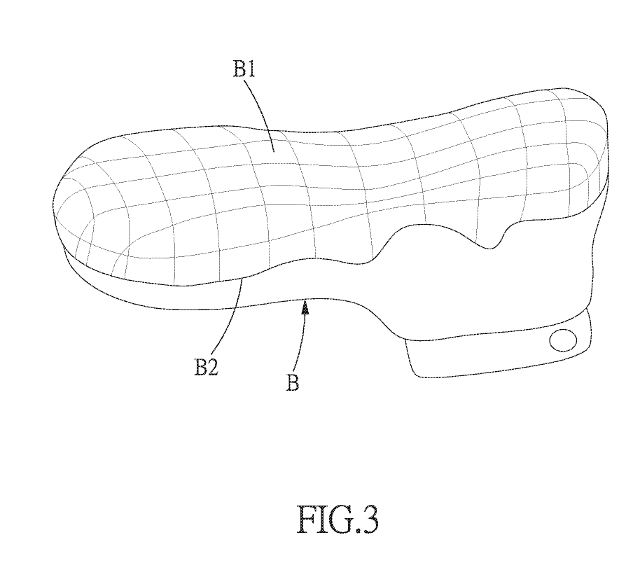

The three-dimensional measurement system C in accordance with the present invention is used to measure the sole A and the upper B which are moved in pair by a conveyor D of a shoe production line. The “sole A and upper B in pair” here means that the sole A and the upper B can constitute a complete shoe. FIG. 1 shows that a shoe is formed when the sole A is adhered to the upper B. FIG. 2 shows that the sole A is concave structured and therefore has a three-dimensional sole inner surface A1, and a contour line A2 defining the area of the three-dimensional sole inner surface A1. FIG. 3 shows that the upper B is convex structured and therefore has a three-dimensional upper lower surface B1, and a processing marked line B2 defining an adhering area to which the sole inner surface A1 of the sole A is to be adhered.

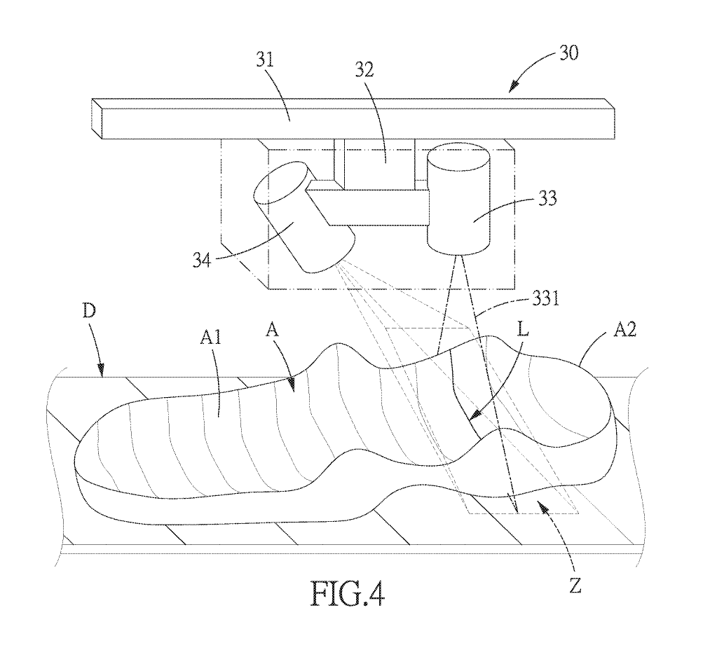

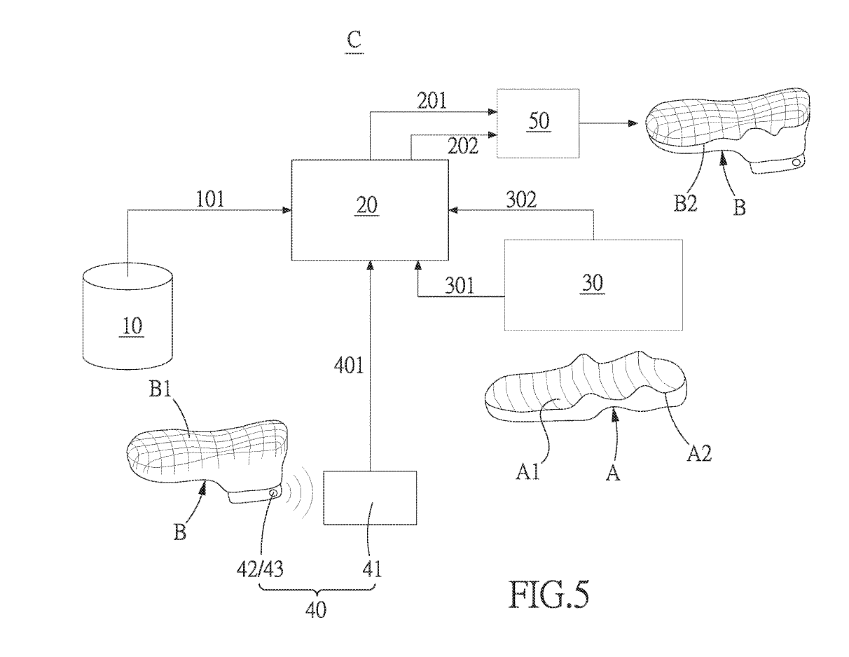

Referring to FIGS. 4 and 5, the three-dimensional measurement system C includes: a database 10, a processor 20, a three-dimensional scanner 30 and an identification device 40, and is used to measure the three-dimensional surface data of the sole inner surface A1, so that the location of the processing marked line B2 of the upper B can be obtained by processing the three-dimensional surface data of the sole inner surface A1 and the three-dimensional surface data of the upper B.

The database 10 is stored with three-dimensional surface data 101 of various to-be-adhered uppers B. In this embodiment, the upper B is made based on a CNC (computer numerical control) shoe last, therefore, the upper B is conformed to the shape of the shoe last. The three-dimensional surface data of the last corresponding to specific uppers B can be stored in the database 10 and used as the three-dimensional surface data 101 of the uppers B. The method for obtaining the three-dimensional surface data 101 of the uppers B is not limited thereto and can also be obtained by digitizing the scanned images.

The three-dimensional scanner 30 is mounted on the conveyor D via a slideway 31 to scan the sole A. A projector 33 and a video camera 34 are slidably mounted on the slideway 31 via a rack 32. The projection lines L of the light rays 331 generated from the projector 33 are located within the coverage area Z of the video camera 34. The projection lines L of the three-dimensional scanner 30 are projected onto different parts of the sole inner surface A1 of the sole A to create a set of deformation 301 along with the movement of the sole A. Measuring the displacement distance between the rack 32 and the slideway 31 can create a projection-line displacement data 302. In this embodiment, the measurement is performed by the three-dimensional scanner 30 based on triangulation principle, and the projector 33 is a laser projector for projecting laser rays.

The identification device 40 is used to identify a built-in identification data 401 in a tag of the various uppers B which are carried by the conveyor D. In this embodiment, each of the uppers B on the conveyor D is provided with a RFID tag 42. The identification device 40 is equipped with a reader 41 to read and send the built-in identification data 401 of the RFID tag 42 to the processor 20. Or, each of the uppers B can be provided with a barcode label 43 in which is stored the built-in identification data 401, so as to enable the reader 41 of the identification device 40 to identify the uppers B.

The processor 20 is connected to the database 10, the three-dimensional scanner 30 and the identification device 40, and serves to read the three-dimensional surface data 101 of the database 10 and the built-in identification data 401 to obtain a three-dimensional surface data 202 of the upper which is conformed to the upper B. Then the processor 20 reads the set of deformation 301 and the projection-line displacement data 302 of the three-dimensional scanner 30 to create a three-dimensional inner surface data 201 of the sole. The processor 20 conducts calculation based on the three-dimensional inner surface data 201 of the sole and the three-dimensional surface data 202 of the upper, and transfers the contour line A2 of the sole inner surface A1 of the sole A to the upper lower surface B1 of the upper B to form a processing marked line B2.

What mentioned above are the structural relations of the embodiment of the present invention, for a better understanding of the operation and function of the three-dimensional measurement system C for a marked line for adhering the upper to the sole in accordance with the present invention, reference should be made to FIGS. 1 and 4-6 in conjunction with the following description.

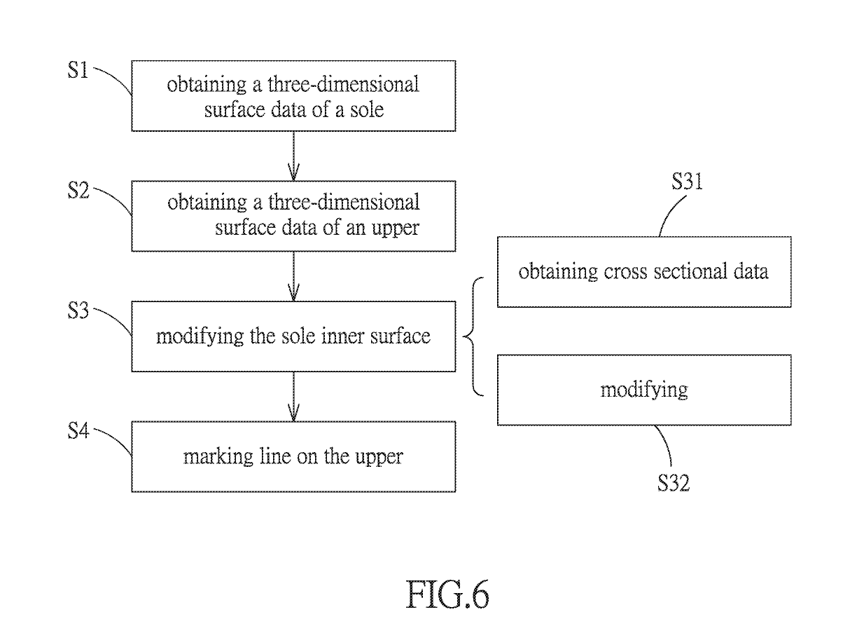

Referring to FIGS. 5 and 6, the three-dimensional measurement method in accordance with the present invention is used to measure the sole A and the upper B which are carried in pair by the conveyor D of a shoe production line, so as to obtain a digital data of the processing marked line B2 for adhering the sole to the upper, and thus achieving the purposes of automatic production, improving production efficiency and quality. The three-dimensional measurement method in accordance with the present invention comprises the steps of: a step S1 of obtaining a three-dimensional surface data of a sole, a step S2 of obtaining a three-dimensional surface data of an upper, a step S3 of modifying the sole inner surface, and a step S4 of marking line on the upper.

The step S1 of obtaining a three-dimensional surface data of a sole includes: moving the sole A carried by the conveyor D into the coverage area Z of the video camera 34 of the three-dimensional scanner 30, shooting and measuring with the three-dimensional scanner 30 the set of deformation 301 formed by the projection lines L moving along with the movement of the sole A and the projection-line displacement data 302 which are then outputted to and processed by the processor 20, so as to obtain the three-dimensional inner surface data 201 of the sole inner surface A1 of the sole A.

The step S2 of obtaining a three-dimensional surface data of an upper includes: moving the upper B carried on the conveyor D to the identification area of the identification device 40, the processor 20 uses the identification device 40 to read a built-in identification data 401 in a tag of the upper B and read the three-dimensional surface data 101 of the upper from the database 10 via the identification data 40, thus obtaining a three-dimensional surface data 202 of the upper which is conformed to the upper B.

The step S3 of modifying the sole inner surface includes: processing, by the processor 20, the three-dimensional inner surface data 201 of the sole and the three-dimensional surface data 202 of the upper, digitally controlling the sole inner surface A1 of the sole A to create a three-dimensional surface which is conformed to the upper lower surface B1 of the upper B on the sole inner surface A1 of the sole A. In this embodiment, the step S3 further includes: a step S3 of obtaining cross sectional data and a step S32 of modifying.

The step S31 of obtaining cross sectional data includes: processing, by the processor 20, the three-dimensional inner surface data 201 of the sole and the three-dimensional surface data 202 of the upper, obtaining curve data of plural cross sections formed when the sole inner surface A1 of the sole A is superimposed on the upper lower surface B1 of the upper B. The step S32 of modifying includes: outputting, by the processor 20, the curve data of plural cross sections to a digital control machine 50, and modifying, by the digital control machine 50, the three-dimensional surface which is formed by the sole inner surface A1 of the sole A is superimposed on the upper lower surface B1 of the upper B, based on the curve data of plural cross sections.

The step S4 of marking a line on the upper includes: processing, by the processor 20, the three-dimensional inner surface data 201 of the sole and the three-dimensional surface data 202 of the upper, and transferring the contour line A2 of the sole inner surface A1 of the sole A to the upper lower surface B1 of the upper B to form the processing marked line B2. In the step S4 of this embodiment, the processor 20 obtains the contour line data of the sole inner surface A1 of the sole A by processing the three-dimensional inner surface data 201 of the sole, then integrates and processes the contour line data of the sole inner surface A1 of the sole A and the three-dimensional surface data 202 of the upper to obtain the positional data of the marked line of the upper B, and outputs the positional data to the digital control machine 50 to allow the digital control machine 50 to process within the area defined by the processing marked line B2 of the upper lower surface B1 of the upper B.

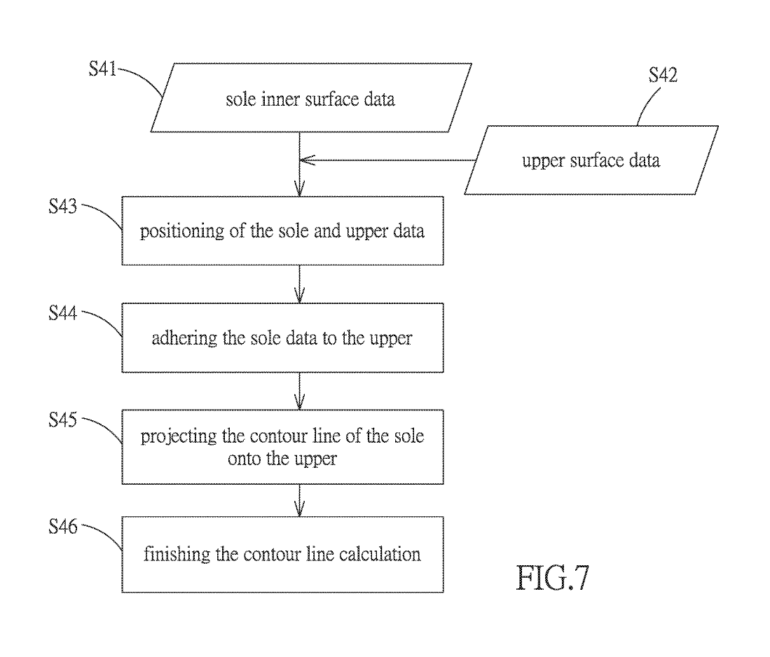

Referring to FIG. 7, steps S41 to S46 are carried out to calculate the contour line. Steps S41, S42 include inputting sole inner surface data and the last inner surface data into the processor 20, the step S43 includes performing primary positioning based on known coordinates, and then performing detailed positioning based on adhering area. Then the step S44 is performed to project the inner surface data of the sole onto the upper, meanwhile, material elasticity can be set to simulate the effect when the sole is attached to the upper. Finally, in the step S45 the contour line after deformation is projected onto the upper data, so as to complete the contour line calculation of the step S46, and the calculated contour line is outputted for later roughening and glue application.

It should be noted that when the sole A and the upper B which are carried in pair are arranged in a parallel manner on the conveyor D, the three-dimensional measurement system C of the present invention can be provided with another scanner to scan the three-dimensional surface data of the upper B in addition to the three-dimensional scanner 30 for scanning the sole inner surface A1. When the three-dimensional scanner 30 are arranged linearly in a front and back manner on the conveyor D, the three-dimensional scanner 30 can scan and send the three-dimensional inner surface data of the sole A and the three-dimensional surface data of the upper B to the processor 20.

In summary, with the three-dimensional measurement system C and the three-dimensional measurement method thereof in accordance with the present invention, the sole A and the upper B can be moved on the production line during the adhering operation. The three-dimensional scanner 30 is capable of acquiring the precise three-dimensional inner surface data of various soles A, which is then used in combination with the three-dimensional measurement method and the three-dimensional surface data of the upper B, to allow the processor 20 to calculate the processing marked line (for adhering the sole to the upper) which can be used as reference parameters for automatic roughening treatment and glue application of the upper B, thus achieving the purposes of automatic production, improving production efficiency and quality.

While we have shown and described various embodiments in accordance with the present invention, it is clear to those skilled in the art that further embodiments may be made without departing from the scope of the present invention.

What is claimed is:

1. A three-dimensional measurement system for a marked line for adhering a sole to an upper, being used to measure the sole and the upper which are carried in pair by a conveyor of a shoe production line, characterized in that: the three-dimensional measurement system includes:
a database stored with three-dimensional surface data of the upper;
a three-dimensional scanner is mounted on the conveyor via a slideway to scan the sole, a projector and a video camera are slidably mounted on the slideway via a rack, projection lines of light rays generated from the projector are located within a coverage area of the video camera, the projection lines of the three-dimensional scanner are projected onto different parts of the sole inner surface of the sole to create a set of deformation during movement of the sole, measuring displacement distance between the rack and the slideway can create a projection-line displacement data;
an identification device is used to identify a built-in identification data in a tag of the upper carried by the conveyor; and
a processor is connected to the database, the three-dimensional scanner and the identification device, and serves to read the three-dimensional surface data of the database and the built-in identification data to obtain a three-dimensional surface data of the upper which is conformed to the upper, the processor reads the set of deformation and the projection-line displacement data of the three-dimensional scanner to create a three-dimensional inner surface data of the sole, the processor conducts calculation based on the three-dimensional inner surface data of the sole and the three-dimensional surface data of the upper, and transfers the contour line of the sole inner surface of the sole to the upper lower surface of the upper to form a processing marked line.

2. The three-dimensional measurement system as claimed in claim 1, wherein the upper on the conveyor is provided with a radio frequency identification tag, and the identification device is equipped with a reader to read and send the built-in identification data of the radio frequency identification tag to the processor.

3. The three-dimensional measurement system as claimed in claim 1, wherein the upper on the conveyor is provided with a barcode label, and the identification device is equipped with a reader to read and send the built-in identification data of the radio frequency identification tag to the processor.

4. The three-dimensional measurement system as claimed in claim 1, wherein the sole and the upper are arranged in a parallel manner on the conveyor, and the three-dimensional measurement system is provided with another scanner to scan the three-dimensional surface data of the upper.

5. The three-dimensional measurement system as claimed in claim 1, wherein the three-dimensional scanner are arranged linearly in a front and back manner on the conveyor, and the three-dimensional scanner scans the three-dimensional inner surface data of the sole and the three-dimensional surface data of the upper.

6. The three-dimensional measurement system as claimed in claim 1, wherein the projector is a laser projector for projecting laser rays.

7. A three-dimensional measurement method used in combination with the three-dimensional measurement system as claimed 1 in claim to measure the sole and the upper which are carried in pair by the conveyor of the shoe production line, and mark the processing marked line for adhering the sole to the upper, characterized in that the three-dimensional measurement method comprises:
a step of obtaining the three-dimensional surface data of the sole includes:
moving the sole carried by the conveyor into a coverage area of the video camera of the three-dimensional scanner, shooting and measuring with the three-dimensional scanner the set of deformation formed by the projection lines and the projection-line displacement data which are then outputted to and processed by the processor, so as to obtain the three-dimensional inner surface data of the sole inner surface of the sole;
a step of obtaining a three-dimensional surface data of an upper includes: moving the upper carried on the conveyor to an identification area of the identification device, the processor uses the identification device to read the built-in identification data in a tag of the upper and read the three-dimensional surface data of the upper from the database via the identification data, thus obtaining the three-dimensional surface data of the upper which is conformed to the upper;
a step of modifying the sole inner surface includes: processing, by the processor, the three-dimensional inner surface data of the sole and the three-dimensional surface data of the upper, digitally controlling the sole inner surface of the sole to create a three-dimensional surface which is conformed to the upper lower surface of the upper on the sole inner surface of the sole; and
a step of marking a line on the upper includes: processing, by the processor, the three-dimensional inner surface data of the sole and the three-dimensional surface data of the upper, and transferring the contour line of the sole inner surface of the sole to the upper lower surface of the upper to form the processing marked line.

8. The method as claimed in claim 7, wherein the tag is a radio frequency identification tag or a barcode label which allows the reader of the identification device to read the built-in identification data via Radio frequency identification technology or barcode recognition technology.

9. The method as claimed in claim 7, wherein the step of modifying the sole inner surface further includes: a step of obtaining cross sectional data and a step of modifying;
the step of obtaining cross sectional data includes: processing, by the processor, the three-dimensional inner surface data of the sole and the three-dimensional surface data of the upper with the processor, obtaining curve data of plural cross sections formed when the sole inner surface of the sole is superimposed on the upper lower surface of the upper; and
the step of modifying includes: outputting, by the processor, the curve data of plural cross sections to a digital control machine, and modifying, by the digital control machine, the three-dimensional surface which is formed by the sole inner surface of the sole is superimposed on the upper lower surface of the upper, based on the curve data of plural cross sections.

10. The method as claimed in claim 7, wherein in the step of marking a line on the upper, the processor obtains the contour line data of the sole inner surface of the sole by processing the three-dimensional inner surface data of the sole, then integrates and processes the contour line data of the sole inner surface of the sole and the three-dimensional surface data of the upper to obtain the positional data of the marked line of the upper, and outputs the positional data to the digital control machine to allow the digital control machine to process within the area defined by the processing marked line of the upper lower surface of the upper.
